(19) United States
(12) Patent Application Publication
(10) Pub. No.: US 2021/0306537 A1
(43) Pub. Date: Sep. 30, 2021

(54) VEHICULAR WINDSHIELD-MOUNTED FORWARD VIEWING CAMERA WITH COATED STRAY LIGHT SHIELD REGION OF HOUSING

(71) Applicant: Magna Electronics Inc., Auburn Hills, MI (US)

(72) Inventor: Martin Solar, Erlenbach (DE)

(21) Appl. No.: 17/301,075

(22) Filed: Mar. 24, 2021

Related U.S. Application Data
(60) Provisional application No. 62/994,323, filed on Mar. 25, 2020.

(51) Int. Cl. H04N 5/225; H04N 7/18; G03B 17/56; G02B 5/00; B60R 11/04

(52) U.S. Cl. CPC H04N 5/22521; H04N 5/2252; H04N 7/18; B60R 2011/0026; G02B 5/003; B60R 11/04; G03B 17/561

(57) ABSTRACT

A vehicular camera module configured to be disposed at an in-cabin side of a windshield of a vehicle includes a housing and a camera disposed at the housing. The camera includes an imager having a two dimensional array of at least one million photosensing elements arranged in rows and columns. The camera includes a lens. With the vehicular camera module disposed at the in-cabin side of the windshield, the camera views through the windshield and forward of the vehicle. The vehicular camera module includes a glare shield region below and forward of the lens of the camera. The glare shield region includes a planar surface that is coated with a light absorbing coating. The coated glare shield region, with the vehicular camera module disposed at the in-cabin side of the windshield, reduces glare light incident at the lens of the camera.

### CROSS REFERENCE TO RELATED APPLICATION

The present application claims the filing benefits of U.S. provisional application Ser. No. 62/994,323, filed Mar. 25, 2020, which is hereby incorporated herein by reference in its entirety.

### FIELD OF THE INVENTION

The present invention relates generally to a vehicular vision system and, more particularly, to a vehicular vision system that utilizes a forward viewing windshield-mounted camera.

### BACKGROUND OF THE INVENTION

Use of imaging sensors in vehicle imaging systems is common and known. Examples of such known systems, with forward viewing cameras mounted at and behind the vehicle windshield, are described in U.S. Pat. Nos. 9,871,971 and/or 9,596,387, which are hereby incorporated herein by reference in their entireties.

### SUMMARY OF THE INVENTION

The present invention provides a driver assistance system or vision system or imaging system for a vehicle that utilizes a windshield-mounted forward viewing camera to capture image data representative of images exterior and forward of the vehicle. The camera comprises a lens and an imager having a two dimensional array of photosensing elements. The windshield-mounted camera module includes a stray light shield or glare shield disposed below and in front of the imager and lens. The stray light shield or glare shield comprises a light absorbing coating or film applied at a non-contoured or non-ribbed surface of the housing of the camera module that is disposed below and in front of the camera. The light absorbing coating is applied or painted onto the surface of the housing at a light shielding region to limit glare light incident at the light shielding region from reflecting to the lens of the camera.

These and other objects, advantages, purposes and features of the present invention will become apparent upon review of the following specification in conjunction with the drawings.

### BRIEF DESCRIPTION OF THE DRAWINGS

FIG. 1 is a perspective view of a vehicle with a vision system that incorporates a windshield-mounted camera in accordance with the present invention;

FIG. 2 is a perspective view of the windshield-mounted camera; and

FIG. 3 is another perspective view of a windshield-mounted camera, showing the coated stray light shield.

### DESCRIPTION OF THE PREFERRED EMBODIMENTS

A vehicle vision system and/or driver assist system and/or object detection system and/or alert system operates to capture images exterior of the vehicle and may process the captured image data to display images and to detect objects at or near the vehicle and in the predicted path of the vehicle, such as to assist a driver of the vehicle in maneuvering the vehicle in a rearward direction. The vision system includes an image processor or image processing system that is operable to receive image data from one or more cameras and provide an output to a display device for displaying images representative of the captured image data. Optionally, the vision system may provide display, such as a rearview display or a top down or bird's eye or surround view display or the like.

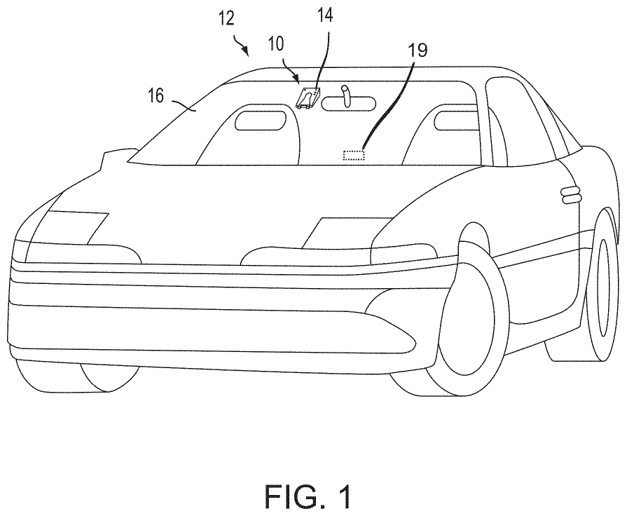

Referring now to the drawings and the illustrative embodiments depicted therein, vision system 10 for a vehicle 12 includes at least one windshield-mounted camera module 14 comprising an exterior viewing imaging sensor or camera 18, such as a forward viewing imaging sensor or camera, which may be disposed at and behind the windshield 16 of the vehicle 12 and viewing forward through the windshield 16 so as to capture image data representative of the scene occurring forward of the vehicle 12 (FIG. 1). Optionally, the vision system 10 may include multiple exterior viewing imaging sensors or cameras, such as a forward viewing camera at the front of the vehicle 12, and a sideward/rearward viewing camera at respective sides of the vehicle 12, and a rearward viewing camera at the rear of the vehicle 12, which capture images exterior of the vehicle 12. The camera or cameras each include a lens for focusing images at or onto an imaging array or imaging plane or imager of the camera.

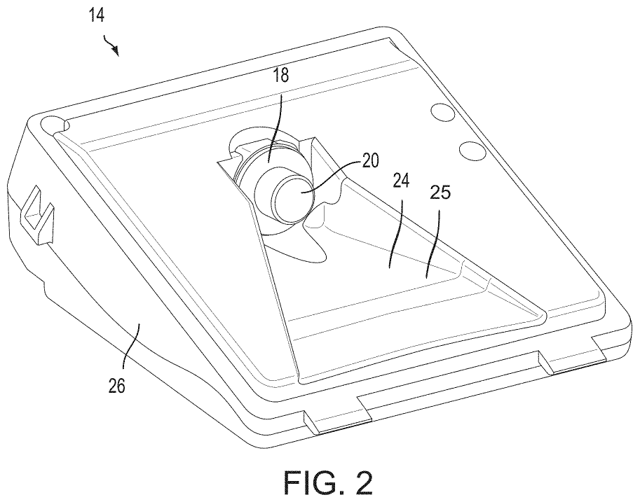

As shown in FIGS. 1 and 2, the windshield-mounted camera module 14 includes the forward viewing camera 18 (having a lens 20 that focuses or images light onto an imager of the camera 18). With the camera module 14 disposed at the windshield 16 of the vehicle 12, the forward viewing camera 18 views through the windshield 16 and forward of the vehicle 12, such as for a machine vision system (such as for traffic sign recognition, headlamp control, pedestrian detection, collision avoidance, lane marker detection and/or the like). The vision system 10 includes a control or electronic control unit (ECU) 19 having electronic circuitry and associated software. The electronic circuitry includes a data processor or image processor that is operable to process image data captured by the camera 18 or cameras, whereby the ECU 19 may detect or determine the presence of objects or the like and/or the system provide displayed images at a display device for viewing by the driver of the vehicle. For example, a control and/or display device may be disposed at or be part of or incorporated in or at an interior rearview mirror assembly 20 of the vehicle, or the control and/or the display device may be disposed elsewhere at or in the vehicle. The data transfer or signal communication from the camera 18 to the ECU 19 may comprise any suitable data or communication link, such as a vehicle network bus or the like of the equipped vehicle.

The camera module 14 and forward viewing camera 18 is installed in the upper center of the vehicle windshield 16. From this vantage point, the camera 18 captures image data representative of the view through the windshield 16 and at least forward of and in front of the vehicle 12. The image data captured by the camera 18 is then processed by intelligent algorithms for object detection, such as for detecting vehicles, pedestrians, road markings, traffic signs and other such information of interest ahead of the vehicle and/or in the field of view of the camera. The camera module 14 includes a stray light shield 24 disposed below and in front of the camera 18 and lens 20. The stray light shield 24 may comprise a portion of the housing 26 of the camera module 14 (that houses circuitry and part of the camera 18, with the lens 20 protruding through an aperture in the housing 26) and may be integrally formed with the housing 26. Optionally, the stray light shield 24 may comprise a separately formed and detachably attached stray light shield 24 that is attached at the housing 26 below and in front of the camera 18.

Use of a stray light shield 24 with the forward facing camera 18 is designed to eliminate light reflections caused by dashboard, camera housing, interior infotainment displays, mounting features and similar factors. The stray light shield 24 is designed to eliminate as much light reflections as possible of incoming light (including visible and/or infrared or near infrared light, depending on the particular application and spectral sensitivity of the camera). Typical stray light shields include specific or complex ribbed or structured designs and different types of plastic material with a flock sheet or flock paper adhesively applied to the housing.

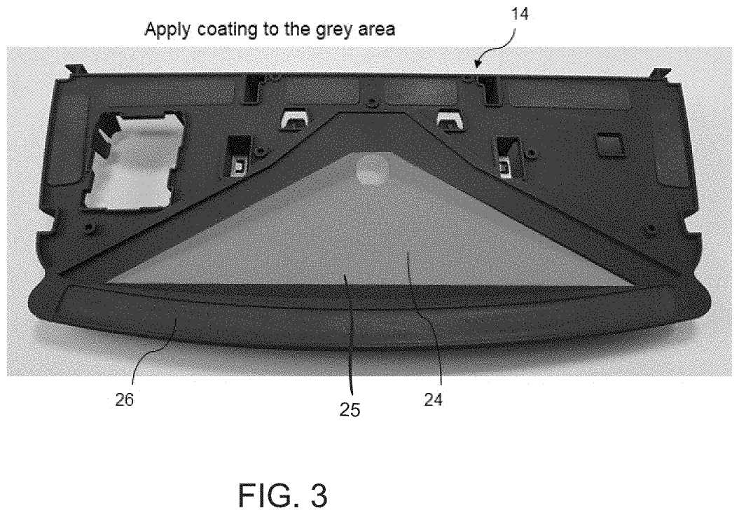

The stray light shield 24 of the present invention comprises a plastic (or any other suitable material, such as metal, such as aluminum or other suitable metallic material) component including a coated surface 25. The coated surface 25 is coated with a material that provides a light absorption property and absorbs light incident at the stray light shield 24 to reduce, limit, or minimize glare light from reaching the camera lens 20 and the imager of the camera 18. The coated surface 25 of the housing 26 (see FIG. 3) provides for light absorption via the material properties of the coating or film, such as via nano-structures of the coating or film. The coating of the coated surface 25 may be painted or coated onto the surface of the housing 26 (optionally a thin film may be applied or adhered to the surface of the housing 26). As shown in FIG. 3, the coated surface or region of the coated surface 25 comprises a generally planar region in front and below the camera lens 20 and side regions that extend upward from the coated planar region.

The light absorbing shield and coated surface 25 portion of the housing 26 thus provides the stray light shield 24 with light absorption properties without any specific surface geometry such as a geometrical arrangement of ribs (such as described in U.S. Pat. No. 9,871,971, which is hereby incorporated herein by reference in its entirety) and without any additional or separately formed sheet material. Thus, the housing 26 of the camera module 14 may be formed via injection molding of any suitable plastic or polymeric material (or metal material), and the shield area or portion of the housing may provide a smooth or non-ribbed surface, and the coating may be painted onto or applied at the shield area to provide the stray light shield. The vehicular camera module 14, when disposed at the in-cabin surface of the windshield 16, makes intimate contact with the windshield surface at least partially around a periphery of the stray light shield 24, and includes a cover element that is disposed at and surrounds the housing 26 and the stray light shield 24 at the windshield 16.

The coating at the coated surface 25 can be painted onto or applied at any suitable substantially flat or planar (non-ribbed) surfaces of the metal or plastic camera housing 26. The usage of such coatings (traditionally used in military or aerospace) at the camera housing 26 provides a simpler stray light shield 24 that can be readily established via a simpler injection mold of the housing 26 and a painting process (such as a spraying or depositing process) after the housing 26 is formed. The coating at the coated surface 25 comprises a light absorbing coating that provides enhanced light absorption from all angles. A preferred coating may comprise a plurality of nano-structures or generally vertical tubes deposited or painted onto a generally horizontal surface or region using a chemical vapor deposition process. When light is incident at a such a coated or painted or deposited surface, instead of reflecting off, the light is continually deflected amongst the tubes, eventually becoming absorbed and dissipating into heat. For example, the coating may be similar to the types of coatings available from Surrey NanoSystems Ltd of the United Kingdom under the name VANTABLACK®. VANTABLACK absorbs up to 99.965% of visible light and can be created at around 400 degrees C. (752 degrees F.). The outgassing and particle fallout levels of VANTABLACK are low compared to similar substances. VANTABLACK also has greater resistance to mechanical vibration, and has greater thermal stability, than other similar substances or coatings.

The camera system or camera module 14 of the present invention may utilize aspects of the systems and/or modules described in U.S. Pat. Nos. 9,896,039; 9,871,971; 9,596,387; 9,451,138; 9,380,219; 9,090,213; 7,480,149; 7,289,037; 7,004,593; 6,824,281; 6,690,268; 6,445,287; 6,428,172; 6,420,975; 6,396,397; 6,326,613; 6,278,377; 6,243,003; 6,250,148; 6,172,613 and/or 6,087,953, and/or U.S. Publication Nos. US-2017-0113613 and/or US-2016-0119527, which are all hereby incorporated herein by reference in their entireties.

Therefore, the present invention provides a windshield-mounted camera module 14 that includes a glare shield 24 (i.e., stray light shield 24) that comprises a coated surface 25 of the housing 26 of the camera module 14. The camera module 14 thus may be formed via any suitable manner, and does not require complex ribs or undulating structure at the stray light shield area. Instead, the housing 26 may be formed with a smooth or generally smooth or non-contoured stray light shield 24, and then, after the housing 26 is formed, the stray light shield 24 is coated or painted with the light absorbing material to provide a stray light shield 24 with a coated surface 25 at and in front of and below the camera 18 of the camera housing 26. Accordingly, the coated surface 25 of the stray light shield 25 within the camera module 14 disposed at the in-cabin side of the windshield 16 reduces glare light incident at the lens 20 of the camera 18.

The windshield 16 of the vehicle 12 may include contrasting regions. For example, the windshield 16 includes a blackout region and a light-transmitting window through the blackout region. With such windshields 16, the camera module 14 is disposed at the in-cabin side such that the camera 18 views through the windshield 16 at the light-transmitting window.

The forward viewing camera 18 may be disposed at a windshield electronics module (WEM) or the like. The forward viewing camera 18 may comprise an imager having a two-dimensional array of at least one million photosensing elements arranged in rows and columns. The forward viewing camera 18 may utilize aspects of the systems described in U.S. Pat. Nos. 8,256,821; 7,480,149; 6,824,281 and/or 6,690,268, and/or U.S. Publication Nos. US-2015-0327398; US-2015-0015713; US-2014-0160284; US-2014-0226012 and/or US-2009-0295181, which are all hereby incorporated herein by reference in their entireties.

The vision system 10 includes an image processor operable to process image data captured by the camera 18 or cameras, such as for detecting objects or other vehicles or pedestrians or the like in the field of view of one or more of the cameras 18. The camera module may include a primary circuit board housed in the housing 26 (and electrically connected to the imager or imager circuit board via a flexible electrical connector), with the primary circuit board having a processor for processing image data captured by the forward viewing camera 18. For example, the image processor may comprise an image processing chip selected from the EYEQ™ family of image processing chips available from Mobileye Vision Technologies Ltd. of Jerusalem, Israel, and may include object detection software (such as the types described in U.S. Pat. Nos. 7,855,755; 7,720,580 and/or 7,038,577, which are hereby incorporated herein by reference in their entireties), and may analyze image data to detect vehicles and/or other objects.

Responsive to such image processing, and when an object or other vehicle is detected, the vision system 10 may generate an alert to the driver of the vehicle 12 and/or may generate an overlay at the displayed image to highlight or enhance display of the detected object or vehicle, in order to enhance the driver's awareness of the detected object or vehicle or hazardous condition during a driving maneuver of the equipped vehicle 12.

The vehicle 12 may include any type of sensor or sensors, such as imaging sensors or radar sensors or lidar sensors or ultrasonic sensors or the like. The imaging sensor or camera may capture image data for image processing and may comprise any suitable camera or sensing device, such as, for example, a two dimensional array of a plurality of photosensor elements arranged in at least 640 columns and 480 rows (at least a 640×480 imaging array, such as a megapixel imaging array or the like), with a respective lens focusing images onto respective portions of the array. The photosensor array may comprise a plurality of photosensor elements arranged in a photosensor array having rows and columns. Preferably, the imaging array has at least 300,000 photosensor elements or pixels, more preferably at least 500,000 photosensor elements or pixels and more preferably at least one million photosensor elements or pixels arranged in rows and columns. The imaging array may capture color image data, such as via spectral filtering at the array, such as via an RGB (red, green and blue) filter or via a red/red complement filter or such as via an RCC (red, clear, clear) filter or the like. The logic and control circuit of the imaging sensor may function in any known manner, and the image processing and algorithmic processing may comprise any suitable means for processing the images and/or image data.

For example, the vision system 10 and/or processing and/or camera 18 and/or circuitry may utilize aspects described in U.S. Pat. Nos. 9,233,641; 9,146,898; 9,174,574; 9,090,234; 9,077,098; 8,818,042; 8,886,401; 9,077,962; 9,068,390; 9,140,789; 9,092,986; 9,205,776; 8,917,169; 8,694,224; 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or U.S. Publication Nos. US-2014-0340510; US-2014-0313339; US-2014-0347486; US-2014-0320658; US-2014-0336876; US-2014-0307095; US-2014-0327774; US-2014-0327772; US-2014-0320636; US-2014-0293057; US-2014-0309884; US-2014-0226012; US-2014-0293042; US-2014-0218535; US-2014-0218535; US-2014-0247354; US-2014-0247355; US-2014-0247352; US-2014-0232869; US-2014-0211009; US-2014-0160276; US-2014-0168437; US-2014-0168415; US-2014-0160291; US-2014-0152825; US-2014-0139676; US-2014-0138140; US-2014-0104426; US-2014-0098229; US-2014-0085472; US-2014-0067206; US-2014-0049646; US-2014-0052340; US-2014-0025240; US-2014-0028852; US-2014-005907; US-2013-0314503; US-2013-0298866; US-2013-0222593; US-2013-0300869; US-2013-0278769; US-2013-0258077; US-2013-0258077; US-2013-0242099; US-2013-0215271; US-2013-0141578 and/or US-2013-0002873, which are all hereby incorporated herein by reference in their entireties.

Changes and modifications in the specifically described embodiments can be carried out without departing from the principles of the invention, which is intended to be limited only by the scope of the appended claims, as interpreted according to the principles of patent law including the doctrine of equivalents.

1. A vehicular camera module configured to be disposed at an in-cabin side of a windshield of a vehicle, the vehicular camera module comprising:
a housing;
a camera disposed at the housing, wherein the camera comprises an imager having a two dimensional array of at least one million photosensing elements arranged in rows and columns;
wherein the camera comprises a lens;
wherein, with the vehicular camera module disposed at the in-cabin side of the windshield, the camera views through the windshield and forward of the vehicle;
wherein the vehicular camera module comprises a glare shield region below and forward of the lens of the camera;
wherein the glare shield region comprises a non-ribbed surface coated with a light absorbing coating; and
wherein the coated glare shield region, with the vehicular camera module disposed at the in-cabin side of the windshield, reduces glare light incident at the lens of the camera.

2. The vehicular camera module of claim 1, wherein the housing houses a primary circuit board having a processor for processing image data captured by the camera.

3. The vehicular camera module of claim 1, wherein the windshield includes a blackout region and a light-transmitting window through the blackout region, and wherein, with the vehicular camera module disposed at the in-cabin side of the windshield, the camera views through the windshield at the light-transmitting window.

4. The vehicular camera module of claim 1, wherein the housing comprises a metal housing.

5. The vehicular camera module of claim 1, wherein the glare shield region comprises a non-ribbed surface of the housing of the vehicular camera module.

6. The vehicular camera module of claim 1, wherein the glare shield region comprises a planar surface of the housing of the vehicular camera module.

7. The vehicular camera module of claim 1, wherein the light absorbing coating comprises a plurality of tubes deposited onto the glare shield region.

8. The vehicular camera module of claim 1, wherein the light absorbing coating provides light absorption of light incident at the glare shield region from all angles.

9. The vehicular camera module of claim 1, wherein the vehicular camera module, when disposed at the in-cabin side of the windshield, makes intimate contact with the in-cabin side of the windshield at least partially around a periphery of the glare shield region.

10. The vehicular camera module of claim 1, comprising a cover element that is, with the vehicular camera module disposed at the in-cabin side of the windshield, disposed at and surrounds the housing and the glare shield region at the windshield.

11. The vehicular camera module of claim 1, wherein the lens of the camera protrudes at least partially through an aperture of the housing.

12. A vehicular camera module configured to be disposed at an in-cabin side of a windshield of a vehicle, the vehicular camera module comprising:
a metal housing;
a camera disposed at the metal housing, wherein the camera comprises an imager having a two dimensional array of at least one million photosensing elements arranged in rows and columns;
wherein the camera comprises a lens that protrudes at least partially through an aperture of the metal housing;
wherein, with the vehicular camera module disposed at the in-cabin side of the windshield, the camera views through the windshield and forward of the vehicle;
wherein the metal housing comprises a glare shield region below and forward of the lens of the camera;
wherein the glare shield region comprises a planar surface of the metal housing that is coated with a light absorbing coating; and
wherein the coated glare shield region, with the vehicular camera module disposed at the in-cabin side of the windshield, reduces glare light incident at the lens of the camera.

13. The vehicular camera module of claim 12, wherein the metal housing houses a primary circuit board having a processor for processing image data captured by the camera.

14. The vehicular camera module of claim 12, wherein the light absorbing coating comprises a plurality of tubes deposited onto the glare shield region.

15. The vehicular camera module of claim 12, wherein the light absorbing coating provides light absorption of light incident at the glare shield region from all angles.

16. The vehicular camera module of claim 12, wherein the vehicular camera module, when disposed at the in-cabin side of the windshield, makes intimate contact with the in-cabin side of the windshield at least partially around a periphery of the glare shield.

17. A vehicular camera module configured to be disposed at an in-cabin side of a windshield of a vehicle, the vehicular camera module comprising:
a housing;
a camera disposed at the housing, wherein the camera comprises an imager having a two dimensional array of at least one million photosensing elements arranged in rows and columns;
wherein the camera comprises a lens that protrudes at least partially through an aperture of the housing;
wherein the housing houses a primary circuit board having a processor for processing image data captured by the camera;
wherein, with the vehicular camera module disposed at the in-cabin side of the windshield, the camera views through the windshield and forward of the vehicle;
wherein the vehicular camera module comprises a glare shield region below and forward of the lens of the camera;
wherein the glare shield region comprises a planar surface coated with a light absorbing coating that provides light absorption of light incident at the glare shield region from all angles; and
wherein the coated glare shield region, with the vehicular camera module disposed at the in-cabin side of the windshield, reduces glare light incident at the lens of the camera.

18. The vehicular camera module of claim 17, wherein the housing comprises a metal housing.

19. The vehicular camera module of claim 17, wherein the glare shield region comprises a planar surface of the housing of the vehicular camera module.

20. The vehicular camera module of claim 17, wherein the light absorbing coating comprises a plurality of tubes deposited onto the glare shield region.
